(19) United States
(12) Patent Application Publication
(10) Pub. No.: US 2019/0118421 A1
(43) Pub. Date: Apr. 25, 2019

(54) COOLING AIRFLOW FOR A HEATING LAMP

(71) Applicant: HEWLETT-PACKARD DEVELOPMENT COMPANY, L.P., Houston, TX (US)

(72) Inventors: Emilio Carlos Cano, Sant Cugat del Valles (ES); Ignacio Alejandre, Sant Cugat del Valles (ES); Esteve Comas, Sant Cugat del Valles (ES)

(21) Appl. No.: 16/094,734

(22) PCT Filed: May 12, 2016
(86) PCT No.: PCT/US2016/032038

§ 371 Date: Oct. 18, 2018

(51) Int. Cl. B29C 35/16; B29C 64/165; B29C 64/295

(52) U.S. Cl. CPC B29C 35/16; B29C 64/165; B33Y 30/00; B29C 2035/1658; B29C 64/295

(57) ABSTRACT

In some examples, a lamp assembly for a printing system includes a heating lamp to generate heat in an active region of the printing system, and a housing comprising an inner chamber containing the heating lamp, an airflow inlet to receive a cooling airflow for provision into the inner chamber of the housing to cool the heating lamp, and a plurality of exhaust holes through which heated exhaust air is to exit from the inner chamber of the housing, the plurality of exhaust holes formed in a wall of the housing. The lamp assembly further includes an attachment element to attach the lamp assembly to a carriage of the printing system.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIGS. 1A and 1B are different views of a lamp assembly according to some examples.

FIG. 2A is a perspective view of a lamp assembly according to further examples.

FIG. 2B is a perspective view of a lamp assembly with a side wall removed, in accordance to further examples.

FIG. 3 is a perspective view of a carriage assembly for a three-dimensional (3D) printing system, according to some examples.

FIG. 4 is an enlarged view of a portion of the carriage assembly of FIG. 3, according to some examples.

FIG. 5 is a simplified block diagram of a 3D printing system according to some examples.

FIG. 6 is a flow diagram of a process of forming a heating assembly, according to some examples.

### DETAILED DESCRIPTION

In a 3D printing system, a build material (or multiple different build materials) can be used to form a 3D object, by depositing the build material(s) as successive layers until the final 3D object is formed. In some examples, a build material can include a powdered build material that is composed of particles in the form of fine powder or granules. The powdered build material can include metal particles, plastic particles, polymer particles, or particles of other materials.

In a 3D printing system, a heating lamp (or multiple heating lamps) can be provided to cause heating of a layer of a build material. A “heating lamp” can refer to a heating source that is activatable to generate energy that can be used to cause heating of a target, which in a 3D printing system can be a layer of build material. An example of a heating lamp is a halogen lamp that can generate visible light or near infrared light energy. In other examples, the heating lamp can include light emitting diodes (LEDs), laser diodes, a lamp to generate medium or far infrared light energy, a xenon lamp, and so forth. The heating of the layer build material can be performed to aid in the fusing of a portion of a layer of powdered build material, where powders in such portions are joined together to form a solid. An agent (e.g. a liquid agent or other substance) can also be applied to such portions of the layer of powdered build material for controlling fusing of the heated portions of the layer of powdered build material. In other examples, the heating of a layer of build material can be performed for other purposes.

During operation of a 3D printing system, the temperature of a heating lamp can rise to an elevated level. If the lamp is not cooled, damage to the lamp can occur. Forced air can be employed to generate a cooling airflow to cool the heating lamp. However, an issue associated with generating an airflow in a 3D printing system is that the airflow can disturb powders of a layer of powdered build material, which can cause some of the powder to disperse in a print chamber. Such powder can be ingested through nozzles of a printhead of the printing system, which can cause clogging of the printhead. Additionally, the disturbed powders can form a powder residue on a lamp, which can adversely affect the operation of the lamp. Moreover, in some cases, contact of build material powder with a lamp at high temperature should generally be avoided.

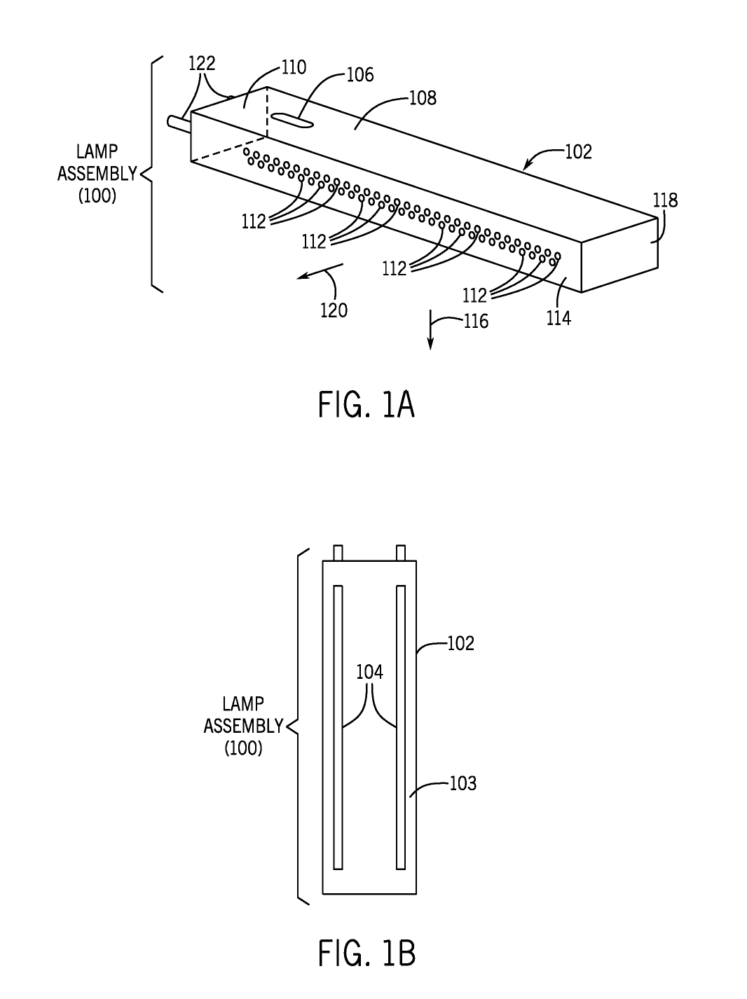

FIG. 1A is a schematic side perspective view of a lamp assembly 100 for a 3D printing system according to some implementations of the present disclosure, and FIG. 1B is a bottom view of the lamp assembly 100. The term “lamp assembly” and “heater assembly” can be interchangeably used, where a “lamp assembly” or “heater assembly” can refer to an assembly that is used to cause heating of a target on a build platform of a 3D printing system. The lamp assembly 100 includes a housing 102 that defines an inner chamber to contain heating lamps 104. In some examples, the housing 102 can be formed of a metal. In other examples, the housing 102 can be formed of a different material. Although two heating lamps 104 are depicted as being included in the housing 102 of the lamp assembly 100 in FIG. 1B, it is noted that in other examples, the housing 102 can contain a different number (e.g. one or greater than one) of heating lamps.

The bottom of the lamp assembly 100 is provided with a plate 103 formed of a substrate that is transmissive to energy produced by the heating lamps 104 to cause heating of a target on a build platform of the 3D printing system. For example, heat generated by the heating lamps 104 can be transmitted through the plate 103 towards a build platform of the 3D printing system. In some examples, the plate 103 can be a glass plate that allows for heat produced by the heating lamps 104 to pass through the glass plate towards the build platform below the lamp assembly 100. In some examples, the glass plate can be formed of quartz glass, borosilicate glass, aluminosilicate glass, or other type glass. In further examples, the plate 103 can be formed of a different material that is transmissive to energy produced by the heating lamps to cause heating of a target on the build platform, or a non-transparent plate such as a silicium plate, germanium plate, and so forth.

The housing has an airflow inlet 106, which can be in the form of an orifice in the housing 102. In other examples, the airflow inlet 106 can include multiple orifices formed in the housing 102.

In examples according to FIG. 1A, the orifice of the airflow inlet 106 is formed in a top wall 108 of the housing 102. In other examples, the orifice of the airflow inlet 106 can be formed on a different wall of the housing 102, such as in an end wall 110 (or another wall) of the housing 102. In further examples, the airflow inlet 106 can include multiple orifices formed in one or in multiple walls of the housing 102. The airflow inlet 106 is to receive a cooling airflow for provision into the inner chamber of the housing 102 to cool the heating lamps 104. An “airflow” can refer to a flow of a gas, such as air or another type of gas (e.g. an inert gas).

The housing 102 is also provided with a pattern of exhaust holes 112 through which heated exhaust airflow is to exit from the inner chamber of the housing 102. The cooling airflow flows through the airflow inlet 106 into the inner chamber of the housing 102. The cooling airflow flows inside the housing 102 to cool the different elements of the lamp assembly 100 that have to be cooled. This cooling airflow is heated in the process, and the heated exhaust airflow exits through the pattern of exhaust holes 112 generally along a direction 120. In some examples, the elements that are cooled by the cooling airflow can include the plate 103, the end portions of the heating lamps 104, and a reflector (discussed further below).

The pattern of exhaust holes 112 can be formed on a side wall 114 provided on a lateral side of the housing 102. In further examples, the pattern of exhaust holes 112 can additionally or alternatively be formed on a different wall, such as an end wall 118 of the housing 102, or formed in both the side wall 114 and the end wall 118 of the housing 102.

During operation of the lamp assembly 100, heat generated by the heating lamps 104 is radiatively directed in a direction 116 towards a build platform of the 3D printing system on which layers of build material are formed. In the orientation of FIG. 1A, the direction 116 is a downward direction through the bottom side of the housing 102. By placing the pattern of exhaust holes 112 on the side wall 114 of the housing 102, the heated exhaust airflow exits from the housing 102 in the direction 120, that is generally parallel (horizontally in the orientation shown in FIG. 1A) to the build platform of the 3D printing system, and the heated exhaust airflow is directed as far as possible from the platform. In some examples, the direction 120 of the heated exhaust airflow can be pointing upwards or downwards at relatively small angles from the horizontal. Directing the heated exhaust airflow in the direction 120 from the higher part of the lamp assembly housing 102 reduces the likelihood of disturbing a layer of powdered build material on the build platform.

By increasing the open area while using relatively small exhaust holes 112, instead of a single larger exhaust hole, the exhaust airflow velocity is reduced at a certain distance from the exhaust holes 112, while also reducing the risk of powder in the print chamber from going inside the lamp assembly housing 102 through the exhaust holes 112 due to movement of the carriage and air movement. Reducing the exhaust airflow velocity reduces the likelihood of disturbing the layer of powder on the build platform. The total area of the exhaust holes can be adjusted by adjusting the number of the exhaust holes.

The housing 102 is also provided with an attachment element 122 that is used to attach the housing 102 to a carriage of the 3D printing system. A “carriage” can refer to a structure that is used for carrying components, including a printhead for emitting an agent, as well as other components such as the lamp assembly 100, a sensor to sense a respective parameter, and so forth.

In some examples, the attachment element 122 includes posts that can fit into respective holes in a mounting structure of the carriage to attach the lamp assembly 100 to the carriage. In other examples, the attachment element 122 can include alternative or additional components to attach to the carriage (discussed further below).

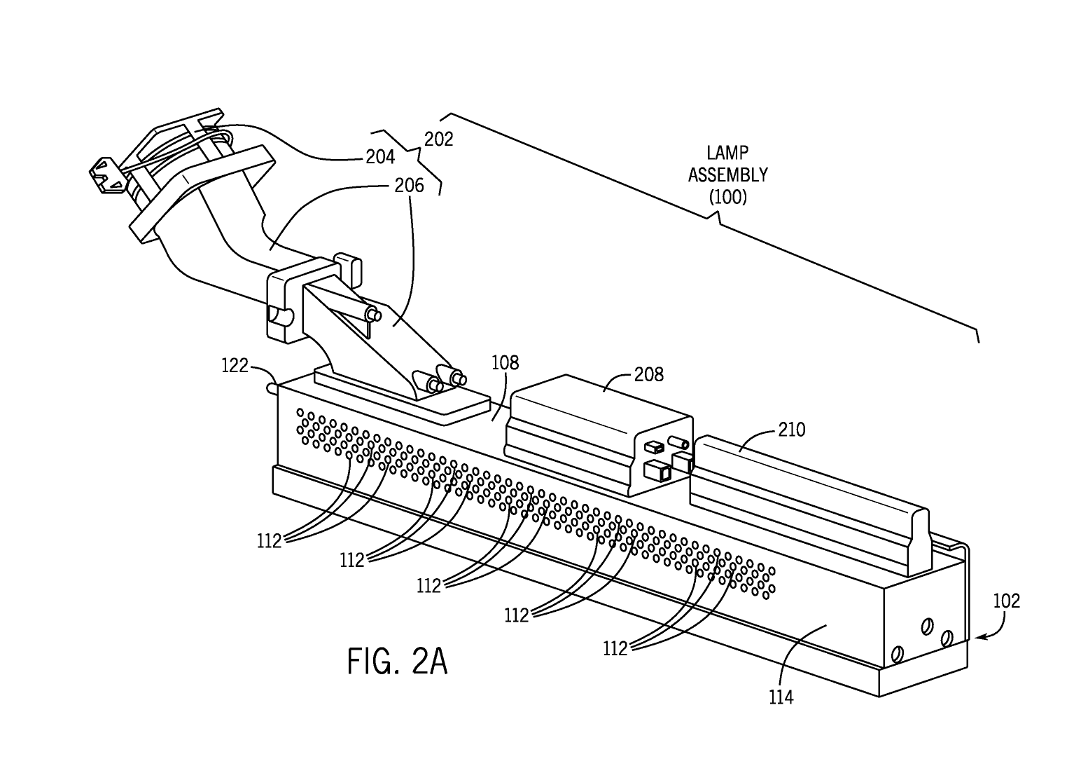

FIG. 2A is a side perspective view of the lamp assembly 100 according to further examples. The lamp assembly 100 of FIG. 2A includes an active cooling subsystem 202 that includes an airflow generator 204 (e.g. including a fan or multiple fans, or a compressed air intake) and an air duct 206 through which an airflow produced by the airflow generator 204 can be transported to the airflow inlet 106 (FIG. 1A) of the housing 102 of the lamp assembly 100. The active cooling subsystem 202 can also be attached to the carriage of the 3D printing system.

In examples according to FIG. 2A, additional components can be attached to the top wall 108 of the housing 102. For example, a lamp connector assembly 208 can be attached to the top wall 108 of the housing 102, where the lamp connector assembly 208 can include connectors to electrically connect the heating lamps 104 to electrical cables for providing power and control signals to the heating lamps 104. The control signals can be used to control the activation and deactivation of the heating lamps 104.

In addition, a handle 210 can be attached to the top wall 108 of the housing 102, to allow a user to grip the handle 210 to manipulate the lamp assembly 100, such as to attach the lamp assembly 100 to the carriage or to remove the lamp assembly 100 from the carriage. In other examples, the lamp connector assembly 208 or the handle 210 can be omitted or placed elsewhere on the housing 102.

FIG. 2B shows the lamp assembly 100 with the side wall 114 removed so that components inside the housing 102 are visible. A reflector 220 is provided above the heating lamps 104, where the reflector 220 is used to reflect heat energy from the heating lamps 104 downwardly in the orientation shown in FIG. 2B. In addition, below the lamps 104 are a plate 222 and the plate 103 discussed above. The plate 222 is above the plate 103. Both the plates 222 and 103 can be formed of glass or other suitable material as discussed further above in connection with the plate 103. The cooling airflow that flows into the inner chamber of the housing 102 can cool the plates 222 and 103, the end portions 224 and 226 of the heating lamps 104, and the reflector 220.

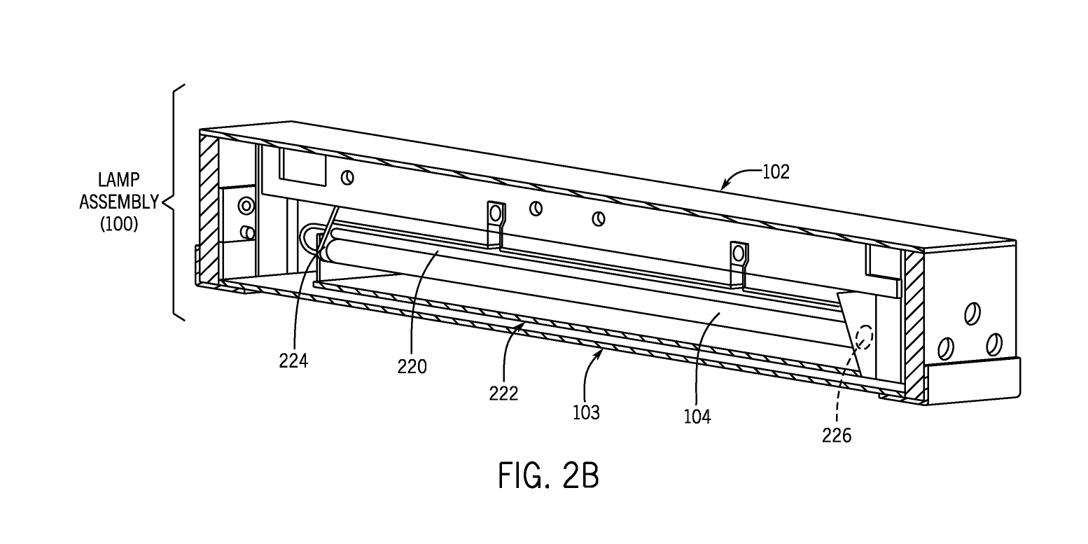

FIG. 3 is a perspective view of an example carriage assembly 300. The carriage assembly 300 includes a carriage 302 and two lamp assemblies 100-1 and 100-2 attached to two different sides of the carriage 302. The printhead housing 302 can be used to carry one or multiple printheads (not shown) that are used to emit an agent (or agents), such as a liquid agent or other substance. Although two lamp assemblies 100-1 and 100-2 are shown as attached to the carriage 302, it is noted that in other examples, a different number (one or greater than one) of lamp assemblies can be included in the carriage assembly 300.

Each lamp assembly 100-1 and 100-2 can have the arrangement of the lamp assembly 100 shown in FIG. 2A. The attachment element 122 of each lamp assembly 100-1 and 100-2 can be connected into corresponding attachment holes in a mounting structure 304 of the carriage 302.

As further shown in FIG. 3, a cover 308-1 can be provided to cover the top part of the lamp assembly 100-1, and a cover 308-2 can be provided to cover the top part of the lamp assembly 100-2.

The lamp assembly 100-1 includes an active cooling subsystem 202-1 that includes an airflow generator 204-1 and an air duct 206-1. Similarly, the lamp assembly 100-1 includes an active cooling subsystem 202-2 that includes an airflow generator 204-2 and an air duct 206-2. The active cooling subsystems 202-1 and 202-2 are similar in design to the active cooling subsystem 202 described in connection with FIG. 2A.

The carriage 302 further includes a support panel 306 to which the active cooling subsystems 202-1 and 202-2 are mounted. The support panel 306 can be attached to the mounting structure 304.

Although not shown, other components can be part of the carriage assembly 300, including cables, an active cooling subsystem for printheads in the carriage 302, and so forth.

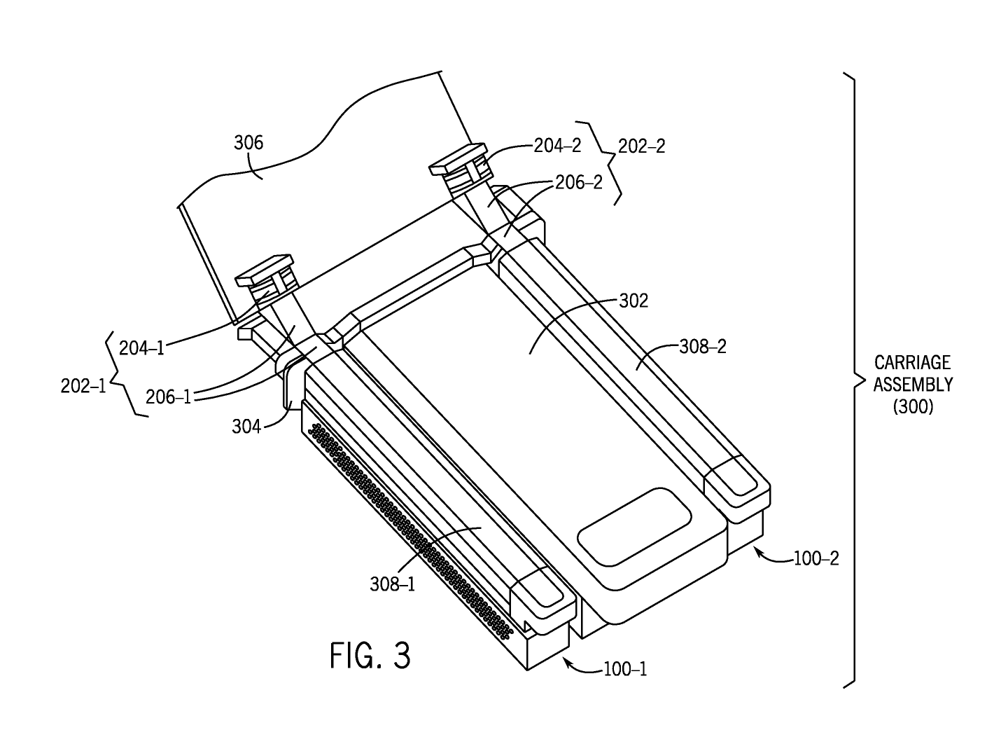

FIG. 4 is an enlarged view of a portion of the carriage assembly 300 of FIG. 3. In the view of FIG. 4, a portion of the lamp assembly 100-1 and the carriage 302 is visible. FIG. 4 shows a further attachment element (in addition to the attachment element 122 shown in FIGS. 1A, 1B, and 2A) of the lamp assembly 100-1 used to attach the lamp assembly 100-1 to the carriage 302. The lamp assembly 100-2 similarly includes the further attachment element.

This further attachment element is in the form of an L-shaped attachment plate 402 that is attached to a side wall of the housing 102 of the lamp assembly 100-1. The L-shaped attachment plate 402 has a mounting portion 403 that is bent from the main body of the attachment plate 402. The mounting portion 403 has an opening through which a screw 410 or other type of fastener can pass through.

An L-shaped fixing plate 404 is attached to side wall 408 of the carriage 302. The L-shaped fixing plate 404 has a mounting portion 406 that is bent from the main body of the fixing plate 404. The mounting portion 406 of the fixing plate 404 has an opening through which the screw 410 or other fastener can pass when the hole of the mounting portion 406 is aligned with the hole of the mounting portion 403. The screw 410 or other fastener passes through both the mounting portions 403 and 406 to fix the lamp assembly 100-1 to the carriage 302.

In other examples, a different type of attachment mechanism can be used to fix the lamp assembly 100-1 or 100-2 to the carriage 302.

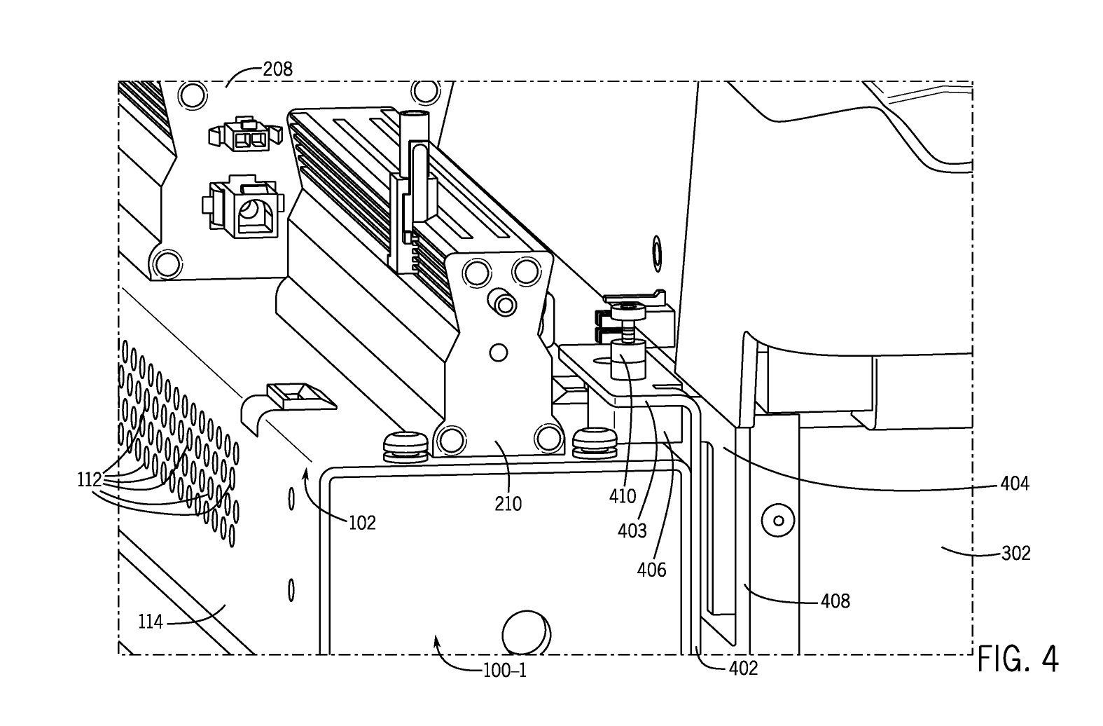

FIG. 5 is a simplified block diagram of an example 3D printing system 500 according to some implementations. The 3D printing system 500 includes a build platform 502 on which a layer 504 of build material is to be provided to form a 3D object. The printing system 500 further includes the carriage 302 and the lamp assembly 100 that is attached to the carriage 302. The carriage 302 and the build platform 502 are moveable with respect to each other. In some examples, the carriage 302 is moveable along an axis 508 while the build platform 502 is stationary. In other examples, the carriage 302 is stationary while the build platform 502 is moveable along the axis 508. In further examples, both the carriage 302 and the build platform 502 are moveable along the axis 508. In additional examples, the carriage 302 and the build platform are moveable with respect to each other along multiple different axes.

The carriage 302 can carry a printhead to emit an agent(s) towards the layer 504 of build material. The emission of the agent(s) occurs in an active region 506 above the build platform 502 of the 3D printing system 500.

As discussed above, the lamp assembly 100 includes a heating lamp (or multiple heating lamps) to generate heat directed towards the build platform 502. The lamp assembly 100 also includes a housing that includes an inner chamber containing the heating lamp(s), an airflow inlet to receive a cooling airflow generated by an airflow generator, and a pattern of exhaust holes through which heated exhaust airflow is to exit from the inner chamber of the housing, where the exhaust holes are dimensioned and the pattern of exhaust holes is design to minimize the exhaust airflow velocity to prevent moving the powder from the build platform 502 while reducing or eliminating the powder ingestion through the exhaust holes 112.

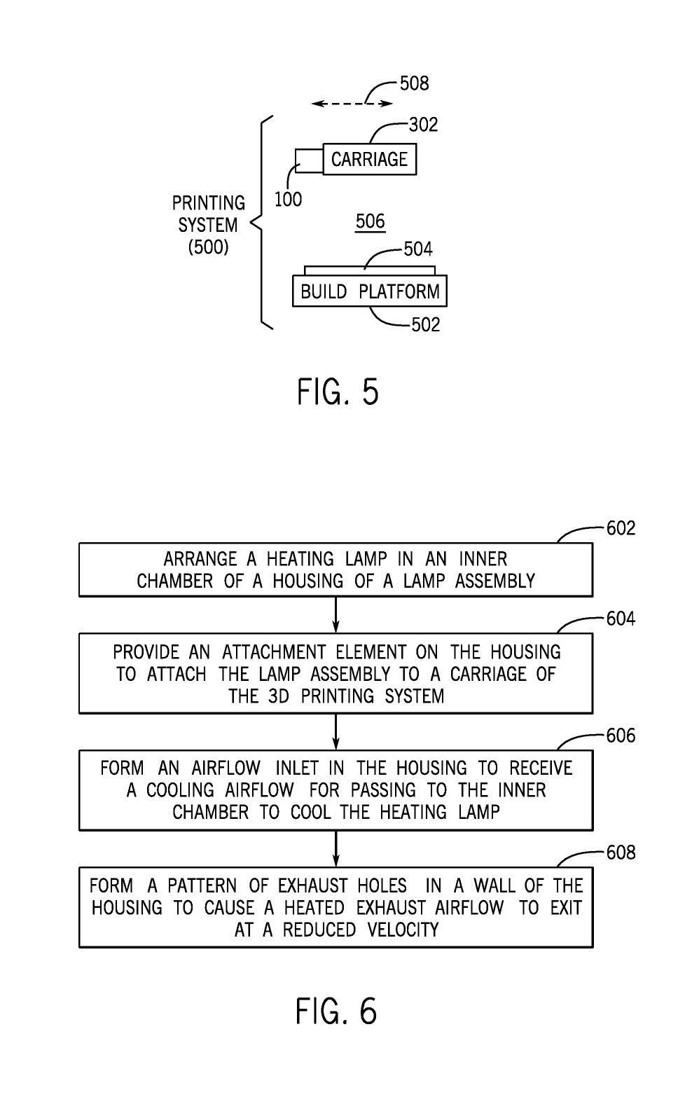

FIG. 6 is a flow diagram of a process of forming a lamp assembly for a 3D printing system. The process of FIG. 6 includes arranging (at 602) a heating lamp in an inner chamber of a housing of the lamp assembly, the heating lamp to generate heat directed towards a build platform of the printing system. The process further includes providing (at 604) an attachment element on the housing to attach the lamp assembly to a carriage in the printing system. The process further includes forming (at 606) an airflow inlet in the housing to receive a cooling airflow for passing to the inner chamber to cool the heating lamp. The process further includes forming (at 608) a pattern of exhaust holes in a wall of the housing to cause a heated exhaust airflow to exit at a reduced velocity while preventing powder from entering the lamp.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A lamp assembly for a printing system, comprising:
a heating lamp to generate heat in the printing system;
a housing comprising an inner chamber containing the heating lamp, an airflow inlet to receive a cooling airflow for provision into the inner chamber of the housing to cool the heating lamp, and a plurality of exhaust holes through which a heated exhaust airflow is to exit from the inner chamber of the housing, the plurality of exhaust holes formed in a wall of the housing; and
an attachment element to attach the lamp assembly to a carriage of the printing system.

2. The lamp assembly of claim 1, wherein the heating lamp is to direct the heat through a first side of the lamp assembly in a first direction towards the active region, and wherein the plurality of exhaust holes are provided in the wall on a second, different side of the lamp assembly through which the heated exhaust airflow exits in a second, different direction.

3. The lamp assembly of claim 2, wherein the first side of the lamp assembly is a bottom side of the lamp assembly, and the second side of the lamp assembly is a lateral side of the lamp assembly.

4. The lamp assembly of claim 2, further comprising a plate provided on the first side of the lamp assembly and attached to the housing, wherein the plate is transmissive to energy generated by the heating lamp.

5. The lamp assembly of claim 1, further comprising an air duct coupled to the airflow inlet, the air duct to transport the cooling airflow from an airflow generator.

6. The lamp assembly of claim 1, wherein the plurality of exhaust holes are to reduce a velocity of the heated exhaust airflow to avoid disturbing a layer of powdered build material on a build platform of the printing system.

7. A printing system comprising:
a carriage; and
a lamp assembly attached to the carriage and comprising:
an airflow generator;
a heating lamp to generate heat directed towards a build platform on which a layer of build material is to be provided to form an object; and
a housing comprising an inner chamber containing the heating lamp, an airflow inlet to receive a cooling airflow generated by the airflow generator, and a plurality of exhaust holes through which a heated exhaust airflow is to exit from the inner chamber of the housing.

8. The printing system of claim 7, wherein the carriage and the build platform are moveable with respect to each other, and wherein the housing of the lamp assembly is fixed to the carriage.

9. The printing system of claim 7, further comprising a second lamp assembly attached to the carriage and comprising:
a second airflow generator;
a second heating lamp to generate heat directed towards the build platform;
a second housing comprising an inner chamber containing the second heating lamp, a second airflow inlet to receive a cooling airflow generated by the second airflow generator, and a plurality of second exhaust holes through which a heated exhaust airflow is to exit from the inner chamber of the second housing, the plurality of second exhaust holes oriented to direct the heated exhaust airflow exiting through the plurality of second exhaust holes.

10. The printing system of claim 7, wherein the housing includes a side wall in which the plurality of exhaust holes are formed.

11. The printing system of claim 10, wherein the housing includes a second wall in which an orifice of the airflow inlet is formed, the second wall being a top wall or an end wall of the housing.

12. The printing system of claim 10, wherein the housing has a bottom side through which the heat generated by the heating lamp is directed.

13. The printing system of claim 12, further comprising a plate provided at the bottom side of the housing, the plate transmissive to energy produced by the heating lamp.

14. A method of forming a lamp assembly for a printing system, comprising:
arranging a heating lamp in an inner chamber of a housing of the lamp assembly, the heating lamp to generate heat directed towards a build platform of the printing system;
providing an attachment element on the housing to attach the lamp assembly to a carriage in the printing system;
forming an airflow inlet in the housing to receive a cooling airflow for passing to the inner chamber to cool the heating lamp; and
forming a pattern of exhaust holes in a wall of the housing to cause a heated exhaust airflow to exit at a reduced velocity .

15. The method of claim 14, wherein the lamp assembly is arranged to direct the generated heat along a first direction towards the build platform, and the exhaust holes are arranged to cause the heated exhaust airflow to exit in a second, different direction.
